(19) United States
(12) Patent Application Publication
(10) Pub. No.: US 2009/0067679 A1
(43) Pub. Date: Mar. 12, 2009

(54) BIOMETRIC DATA PROCESSING

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL SWITZERLAND, CH-1705 Fribourg (CH)

(21) Appl. No.: 11/853,563

(22) Filed: Sep. 11, 2007

(51) Int. Cl. G06K 9/00

(52) U.S. Cl. 382/115

(57) ABSTRACT

Sets of biometric data related to different types of physical stimuli, e.g., a scanning of a fingerprint and a swiping of a fingerprint, can be compared and a transfer function can be generated based on the comparison.

### BACKGROUND

This disclosure relates to biometric data processing.

Biometric sensor devices can include sensor manufactures that can receive various types of biometric stimuli, such as fingerprints. Fingerprint data of a first type can be derived from flat sensors, scanning of rolls, latent prints, etc. Fingerprint data of a second type can be derived by swiped fingerprints. A relative distortion exists between the fingerprint data of a first type and second type due to the biomechanical differences between a flat application of a fingerprint and a swiped application of a fingerprint. The relative distortion may cause matching errors or inaccuracies when attempting to match fingerprint data of the first and second types.

### SUMMARY

The disclosure herein relates to biometric data processing, such as fingerprint data processing. Sets of biometric data related to different types of physical stimuli, e.g., a scanning of a fingerprint and a swiping of a fingerprint, can be collected. In one aspect, the sets of biometric data can be compared and a transfer function can be generated based on the comparison. The transfer function can be applied to biometric data of the first type, e.g., swiped fingerprint data, to generate biometric data of the second type, e.g., flat fingerprint data.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A and 1B are block diagrams of example sensor device systems.

FIG. 2 is an illustration of example representative data points in a fingerprint image.

FIG. 3 is a block diagram of an example fingerprint processing system.

FIG. 4 is a timing diagram of an example transfer function generation process.

FIG. 5 is a flow diagram of an example transfer function generation process.

FIG. 6 is a flow diagram of a first example iterative transfer function generation process.

FIG. 7 is a flow diagram of a second example iterative transfer function generation process.

FIG. 8 is a flow diagram of an example fingerprint generation process.

### DETAILED DESCRIPTION

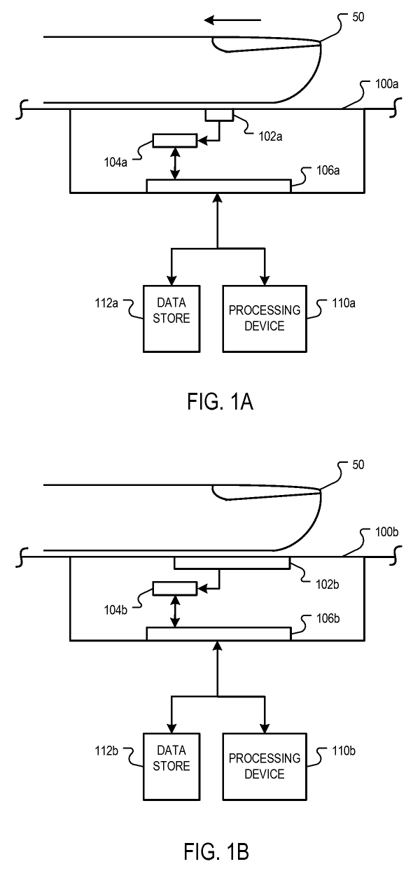

FIGS. 1A and 1B are block diagrams of example sensor device systems 100a and 100b. The example sensing devices 100a and 100b can be biometric sensing devices configured to sense a biometric stimulus, such as the application of a fingerprint. The sensing device 100a is, for example, configured to receive a first physical characteristic stimulus, e.g., a swiping of a fingerprint, and generate a first set of biometric data responsive to the first physical characteristic stimulus. Likewise, the sensing device 100b is configured to receive a second physical characteristic stimulus, e.g., a stationary application of a fingerprint or an image of a fingerprint for scanning, and generate a second set of biometric data responsive to the second physical characteristic stimulus.

The sensing device 100a can include a sensor manufacture 102a coupled to a processing circuit 104a and an input/output circuit 106a. As a stimulus is provided, e.g., a finger 50 is swiped across the sensor manufacture 102a, the sensor manufacture 102a generates electrical signals based on a characteristic of the stimulus, e.g., the fingerprint on the finger 50. In one implementation, a data store 112a can be coupled to the input/output circuit 106a and the processing device 110a and configured to store the biometric data received from the sensor device 100a. The electric signals output by the sensor manufacture 102a are processed by the processing circuit 104a and output through the input/output circuit 106a as biometric data to a processing device 110a, such as a microprocessor executing filtering and recognition algorithms. The example sensing device 100a can generate multiple instances of biometric data per second, with each instance corresponding to a partial image of a stimulus, e.g., a slice of the fingerprint. The multiple instances of biometric data can be processed by the processing device 110a to detect overlapping data and to generate a complete image of the stimulus.

The sensor device 102b operates in a similar manner to the sensor device of 102a; however, the sensor manufacture 102b is of such proportion to receive an entire fingerprint of the finger 50. Thus, the finger 50 can be held stationary against the sensor manufacture 102b and an image of the entire fingerprint can be generated from a single instance of biometric data. Other biometric data collection techniques can also be used, e.g., scanning an image of a rolled fingerprint, for example. The processing circuit 104b, the input/output circuit 106b, and the processing device 110b can provide similar functionality as the processing circuit 104a, the input/output circuit 106a, and the processing device 110a of FIG. 1A.

The processing devices 110a and 110b can execute a matching algorithm on the biometric data to determine whether a corresponding reference sample (e.g., fingerprint) can be identified or authenticated. The matching algorithm can, for example, perform a comparison of the biometric data received to one or more reference data sets. The reference data sets can be fingerprint templates stored during a biometric enrollment process in which one or more users provide a biometric stimulus, e.g., a fingerprint application to a sensor device, or can be provided from a separate data source, e.g., a fingerprint repository, such as fingerprint data from the Automated Fingerprint Identification System (AFIS). An authentication or identification can be made if a match between the biometric data and one or the reference data sets is identified.

In one implementation, the matching algorithm is a correlation-based algorithm, in which a match is performed by superimposing two portions of images (e.g., fingerprint images) and computing the correlation between corresponding pixels. In another implementation, the matching algorithm can be a representative data-based algorithm, in which representative data generated from the biometric data can be compared to one or more representative data templates. In one implementation, the representative data can be derived fingerprint data, e.g., minutiae points.

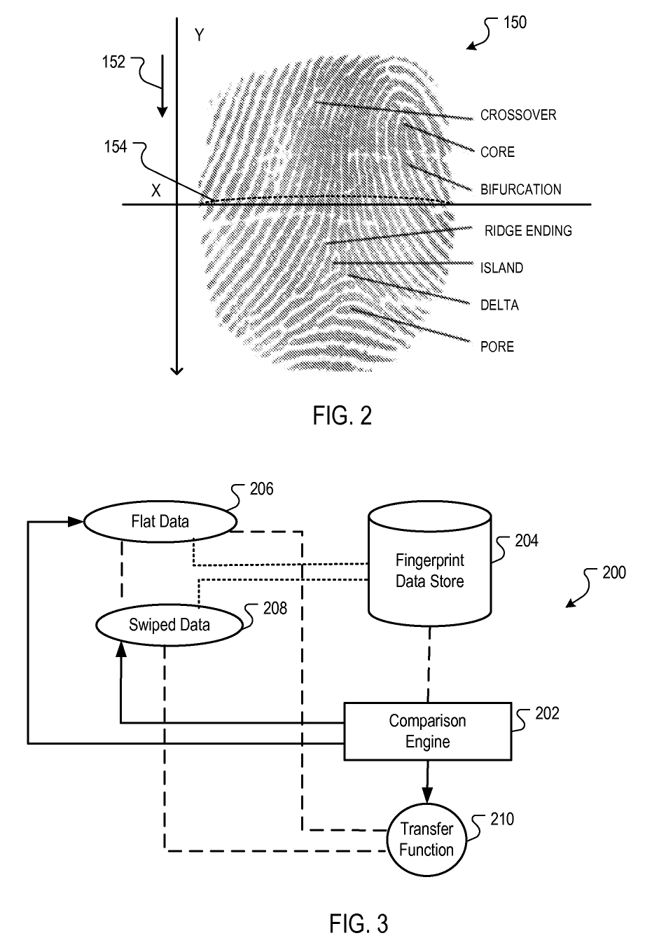

FIG. 2 is an illustration of example image data and representative data points of the image data, e.g., minutiae points, in a fingerprint image 150. Example minutiae points include crossover points, core points, bifurcation points, ridge ending points, island points, delta points, and pore points. Other minutiae points can also be used.

The differing biomechanics of the physical stimuli that are used to generate the first and second types of fingerprint data for the implementations above, however, can cause a relative distortion between the first and second types of fingerprint data for a given fingerprint. Thus, the biometric data generated in response to the swiped fingerprint and the biometric data generated in response to the stationary application of the fingerprint can define slightly different types of biometric data.

For example, when a fingerprint is rolled horizontally across an axis to generate an image for scanning, or held stationary against the sensor manufacture 102b, displacement in the direction of the y-axis is minimal. However, if the finger is swiped, imparting motion and dragged in the direction of the y-axis, a displacement may occur along the x-axis in the direction of the swipe along the y-axis. The displacement will likely be maximized at the center of the fingerprint. For example, if the fingerprint represented by the image 150 is swiped in the direction of the arrow 152, a distortion of the image data corresponding to a displacement curve 154 can occur. The magnitude of the displace curve can vary, depending on the pressure applied during the swipe, the friction between the fingerprint and the sensor manufacture 102a, etc.

Such distortion can decrease the accuracy of matching algorithms, especially when a matching algorithm is comparing biometric data of a first type, e.g. swiped data, to biometric data of a second type, e.g., a flat fingerprint. For example, a security checkpoint, such as an airport immigration and customs checkpoint, may utilize the fingerprint sensing device 102a to collect biometric data from individuals entering a country. The biometric data collected may then be transmitted over a network and compared to biometric data in a data repository, such as fingerprint data stored in the AFIS database. If, however, the biometric data stored in the data repository was collected by a different biometric stimulus, e.g., the application of a flat fingerprint, then the accuracy of the matching algorithm may be decreased.

To minimize performance degradation of matching algorithms, a transfer function can be applied to biometric data of the first type, e.g., swiped fingerprint data, to generate biometric data of the second type, e.g., flat fingerprint data. In some implementations, the transfer function can be applied to image data; in other implementations, the transfer function can be applied to representative data, such as minutiae data.

FIG. 3 is a block diagram of an example fingerprint processing system 200. In some implementations, the fingerprint processing system 200 can, for example, generate a transfer function by iteratively comparing a first and second set of biometric data and mapping the distortion between the two sets of data. In some implementations, the fingerprint processing system 200 can also receive a first set of biometric data and apply the generated transfer function to the first set of biometric data to generate a second set of biometric data.

The fingerprint processing system 200 can, for example, include a comparison engine 202 and a fingerprint data store 204. The fingerprint data store 204 can comprise a unitary data store, such as a hard drive. In another implementation, the fingerprint data store 204 can comprise a distributed data store, such as a storage system that is distributed over a network and/or accessible through a network, such as the AFIS database. Other implementations, however, can also be used.

The fingerprint data store 204 can include a first and second set of biometric data. As described above, the first set of biometric data responsive to a flat fingerprint can include fingerprint data of a first type, i.e., flat data 206, and the second set of biometric data responsive to a swiped fingerprint can include fingerprint data of a second type, i.e., swiped data 208.

In an implementation, to generate a transfer function, e.g., transfer function 210, the system 200 can store one or more training sets of data in the fingerprint data store 204. The one or more training sets of data can be used to derive an empirical transfer function. For example, one or more people can each provide flat fingerprint data and swiped fingerprint data for a finger to generate a training set. The comparison engine 202 can partition the training set into training and test data. For example, flat fingerprint data for a fingerprint can be associated with 100 sets of fingerprint data for the fingerprint resulting from swipes. The first 90 sets of the fingerprint data can be used to train a transfer function, and the remaining 10 sets can be used to test the transfer function. The training process can be repeated for multiple persons, and the resulting transfer functions can be combined to form a general transfer function that can be applied to biometric data collected from the general populace.

In an implementation, the transfer functions can be partitioned according to particular demographics, e.g., data related to gender, age, weight, etc. can be collected for each training set, and the training of the transfer functions can be optimized according to age, gender, sex, etc. For example, a first transfer function may be derived for the general populace of males aged 35-45, and a second transfer function may be derived for the general populace of females aged 38-47, etc.

Example transfer functions can include image transfer functions for use in correlation-based matching algorithms and/or minutiae transfer function for use in minutiae-based matching algorithms. Other transfer functions can also be used. In one implementation, the comparison engine 202 can generate a correlation-based transfer function, e.g., an image distortion filter, by iteratively superimposing two images, e.g., a flat fingerprint image data 206 and multiple swiped fingerprint image data 208 for the same fingerprint, and computing the correlation between corresponding pixels. The transfer function can, for example, be trained so that the first set of biometric data can be adjusted to substantially conform to the second set of biometric data when applied to the first set of biometric data.

For example, the comparison engine 202 can adjust the swiped data 208 by applying the generated transfer function to the swiped data 208. In one implementation, the comparison engine 202 can iteratively correlate the first set of biometric data with the second set of biometric data. For example, the comparison engine 202 can iteratively correlate the flat data 206 and the swiped data 208, and, based on the correlation coefficient generated, the transfer function can be adjusted after each iterative correlation. After each transfer function adjustment, another correlation is performed and another adjustment is made until the correlation value is maximized, exceeds a threshold value, or until an iteration limit is reached.

Thereafter, the transfer function can be tested on the remaining sets of test data to validate the transfer function. If the transfer function is validated, e.g., the transfer function increases the value of the correlation coefficients generated by correlations of the test data to the flat data 206, then the comparison engine 202 can generate transfer functions for other sets of fingerprint data; otherwise, the comparison engine 202 can attempt to generate another transfer function.

In some implementations, validated transfer functions can be combined, e.g., combined according to a central tendency, such as averaging, and tested on a training set of random fingerprint data. If the combined transfer function is validated, the comparison engine 202 can, for example, utilize the transfer function to compare fingerprint data of a first type, e.g., flat data 206, to fingerprint data of a second type, e.g., swiped data 208, for a general populace. For example, the transfer function can be used to adjust an image of a swiped fingerprint obtained at a security checkpoint, and the adjusted images can be compared to fingerprint images stored in a fingerprint repository.

In another implementation, the comparison engine 202 can generate the transfer function by comparing minutiae data representative of a fingerprint. A first set of minutiae data can correspond to flat fingerprint data 206, e.g., a minutiae data set derived from a flat fingerprint image, and second sets of minutiae can correspond to swiped fingerprint data 208, e.g., minutiae data sets derived from multiple images of a swiped fingerprint. Each minutia may be described by a number of attributes, including its location in the fingerprint image, orientation, type, weight based on the quality of the fingerprint image in the neighborhood of the minutiae, etc. In some implementations, the comparison engine 202 can consider each minutia as a triplet m={x, y, Ø} that indicates the x, y minutia location coordinates and the minutia angle Ø. For example, F and Sₖ can be the representation of the flat fingerprint and the swiped fingerprint, respectively, where k is the number of data sets corresponding to k fingerprint swipes. The minutiae sets of the flat data 206 and the swiped data 208 can be given by:

F={m₁,m₂ . . . mₓ×} mᵢ={xᵢ,yᵢ,Øᵢ}, i=1 . . . m

Sₖ={m₁′,m₂′ . . . mₓ′} mj′={xⱼ′,yⱼ′,Øⱼ′}, j=1 . . . n

where m and n denote the number of minutiae in F and S, respectively, and k denotes the number of sets of S. A minutiae mⱼ′ in a set S and a minutia mᵢ in the set F are considered to be matched if the spatial distance (sd) between them is smaller than a given tolerance Zo and the direction difference (dd) between them is smaller than an angular tolerance Øo where:

sd(mᵢ,mᵢ)=square root of [(x′ⱼ−xᵢ)²+(y′ⱼ−yᵢ)²]≦Zo and

dd(mᵢ,mᵢ)=min[|Ø′ⱼ−Øᵢ|, 360°−|Ø′ⱼ−Øᵢ|]≦Øo

In one implementation, the comparison engine 202 can generate a transfer function based on the minutiae matching algorithm by comparing and attempting to find common points between the flat fingerprint minutiae data and the swiped fingerprint minutiae data according to the algorithm above. For example, the comparison engine 202 can determine whether a flat fingerprint minutiae matches a swiped fingerprint minutiae if the spatial distance between the flat fingerprint minutiae data and the swiped fingerprint minutiae data is smaller than a given tolerance, e.g., 2% and the direction difference between the flat fingerprint minutiae data and the swiped fingerprint minutiae data is smaller than an angular tolerance, e.g., 10° according to the algorithm above.

The comparison engine 202 can iteratively generate the transfer function based on how many flat fingerprint minutiae data match swiped fingerprint minutiae data. The comparison engine 202 can, for example, apply the transfer function to the minutiae data of the swiped data 208 and adjust the swiped data 208 according to the transfer function. Adjusting the minutiae data can include changing the fingerprint minutiae data according to the transfer function generated, e.g., adjusting each triplet {xⱼ′, yⱼ′, Øⱼ′} according to a triplet adjustment defined by minutiae triplet filter. After adjusting either of the minutiae data, the comparison engine 202 can compare the minutiae data corresponding to the flat data 206 and swiped data 208 and generate a match score based on the comparison. The match score can reflect the number of minutiae data from one set that matched the minutiae data from the other set. If the match score does not exceeds a threshold value, then the comparison engine 202 can readjust the transfer function. The process can continue until the match score is maximized, exceeds a threshold value, or until an iteration limit is reached.

In some implementations, the comparison engine 202 can identify common minutiae points for multiple data sets and generate the transfer function based on the common points. For example, the comparison engine 202 can compare 50 minutiae points from flat data 206 related to a scanned image of a fingerprint, and 50 minutia points from 50 different sets of swiped data 208 from 50 swipes of the fingerprint, e.g., the point MFLAT1 in the flat data 206 can be compared to the points MSWIPE1-01, MSWIPE1-02 . . . MSWIPE1-50 in the 50 sets of swipe data 206; likewise, MFLAT2 can be compared to MSWIPE2-01, MSWIPE2-02 . . . MSWIPE2-50; . . . MFLAT50 can be compared to MSWIPE50-01, MSWIPE50-02 . . . MSWIPE50-50. Based on these comparisons, the comparison engine 202 can generate a transfer function to minimize the overall differences.

Thereafter, the transfer function can be tested on the remaining sets of test data to validate the transfer function. If the transfer function is validated, e.g., the transfer function increases the value of the match score generated by the comparison of the test data to the flat data 206, then the comparison engine 202 can generate transfer functions for other sets of fingerprint data; otherwise, the comparison engine 202 can attempt to generate another transfer function.

In some implementations, validated transfer functions can be combined, e.g., combined according to a central tendency, such as averaging, and tested on a training set of random fingerprint data. If the combined transfer function is validated, the comparison engine 202 can, for example, utilize the transfer function to compare fingerprint data of a first type, e.g., flat data 206, to fingerprint data of a second type, e.g., swiped data 208. For example, the transfer function can be used to adjust minutiae data derived from a swiped fingerprint obtained at a security checkpoint and compare the adjusted image to fingerprint images stored in a fingerprint repository.

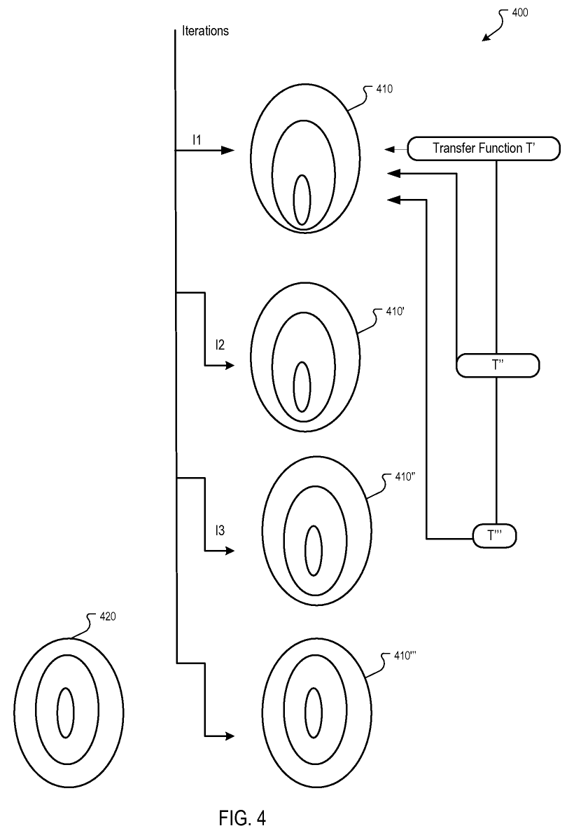

FIG. 4 is a timing diagram 400 of an example transfer function application process. The transfer function generation can, for example, be implemented in the comparison engine 202. Although the timing diagram illustrates generating a transfer function based on only two sets of fingerprint data, e.g., fingerprint data 460 of a first type and fingerprint data 410 of a second type, the transfer function can be generated from multiple sets of fingerprint data, as described above.

The comparison engine 202 can compare a first set of fingerprint data 410 to a second set of fingerprint data 420. As illustrated in FIG. 4, the first set of fingerprint data 410 corresponds to swiped data 208, and the second set of fingerprint data 410 corresponds to flat data 206. During a first iteration I1, a default transfer function T′, is applied to the first set of fingerprint data 410 to generate an adjusted set of fingerprint data 410′. The adjusted set of fingerprint data 410′ is compared to the second set of fingerprint data 420 to determine if the adjusted set of fingerprint data 410′ and the second set of fingerprint data 420 meet a similarity threshold, e.g., exceed a match score for minutiae adjustments or exceed a correlation coefficient value for image adjustments.

Because the similarity threshold is not met, the transfer function is adjusted to T″, and a second iteration I2 is performed. During the second iteration I2, the adjusted transfer function T″ is applied to the first set of fingerprint data 410 to generate another adjusted set of fingerprint data 410″. The adjusted set of fingerprint data 410″ is compared to the second set of fingerprint data 420 to determine if adjusted set of fingerprint data 410″ and the second set of fingerprint data 420 meet the similarity threshold. Because the similarity threshold is not met, a third iteration I3 is performed.

Because the similarity threshold is not met, the transfer function is adjusted to T′″, and a third iteration I3 is performed. During the third iteration I3, the adjusted transfer function T′″ is applied to the first set of fingerprint data 410 to generate another adjusted set of fingerprint data 410′″. The adjusted set of fingerprint data 410′″ is compared to the second set of fingerprint data 420 to determine if adjusted set of fingerprint data 410′″ and the second set of fingerprint data 420 meet the similarity threshold. The similarity threshold is met, and no additional iterations are performed.

In some implementations, the transfer functions can be stored on a biometric sensing device, e.g., in the sensing devices 100a and/or 100b. The sensing devices 100a and 100b can thus be configured to generate biometric data of different types. For example, the sensing device 100a can selectively apply a stored transfer function to generate biometric data corresponding to a flat image from swiped image data generated by the sensor manufacture 102a. Likewise, the sensing device 100b can selectively apply a stored transfer function to generate biometric data corresponding to a swiped image from flat image data generated by the sensor manufacture 102b. Alternatively, the transfer functions can be stored in separate processing devices, e.g., a computer device in data communication with the sensor devices 100a and/or 100b, to adjust various types of biometric data accordingly.

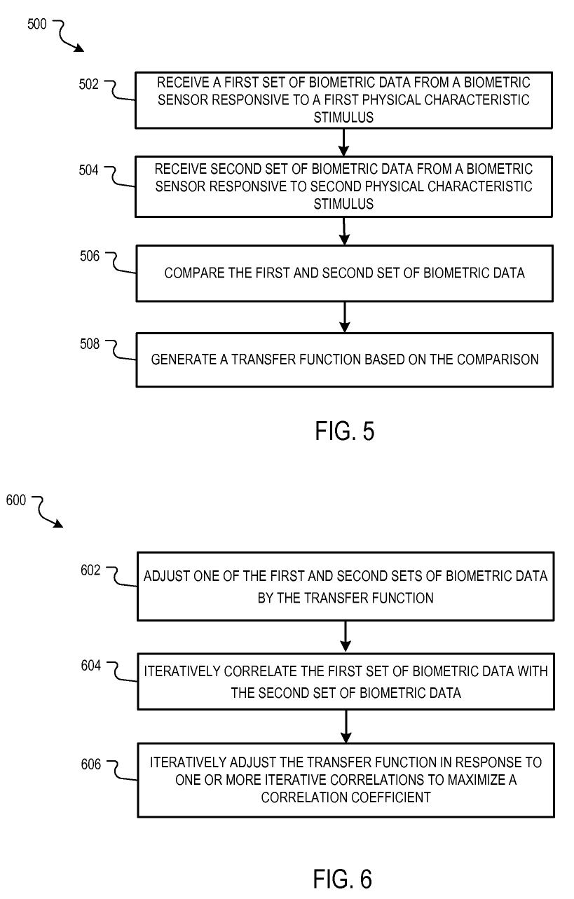

FIG. 5 is a flow diagram of an example transfer function generation process 500. The process 500 can, for example, be implemented in a system such as the fingerprint processing system 200 of FIG. 2.

Stage 502 receives a first set of biometric data from a biometric sensor responsive to a first physical characteristic stimulus. For example, the comparison engine 202 can receive the first set of biometric data from a sensor device, or can receive biometric data generated by a biometric sensor and stored in a data store.

Stage 504 receives a second set of biometric data from a biometric sensor responsive to a second physical characteristic stimulus. The second set of biometric data can be associated with the first set of biometric data, e.g., generated in response to the same fingerprint. For example, the comparison engine 202 can receive the second set of biometric data from another sensor device 100 or can receive biometric data generated by a biometric sensor and stored in a data store.

Stage 506 compares the first and second set of biometric data. For example, the comparison engine 202 can compare the first and second set of biometric data based on a correlation operation or based on a minutiae matching algorithm.

Stage 508 generates a transfer function based on the comparison. For example, the comparison engine 202 can generate a transfer function based on the comparison. The transfer function can be an image data filter for image data, or a minutiae data filter for minutiae data, for example.

FIG. 6 is a flow diagram of a first example iterative transfer function generation process 600. The process 600 can, for example, be implemented in a system such as the fingerprint processing system 200 of FIG. 2.

Stage 602 adjusts one of the first and second sets of biometric data by the transfer function. For example, the comparison engine 202 can adjust one of the first and second sets of biometric data by an image data filter.

Stage 604 iteratively correlates the first set of biometric data with the second set of biometric data. For example, the comparison engine 202 can iteratively correlate the first set of biometric data with the second set of biometric data. After each iterative correlation, stage 606 iteratively adjusts the transfer function in response to one or more iterative correlations to maximize a correlation coefficient. For example, the comparison engine 202 can iteratively adjust the transfer function in response to one or more iterative correlations to maximize a correlation coefficient.

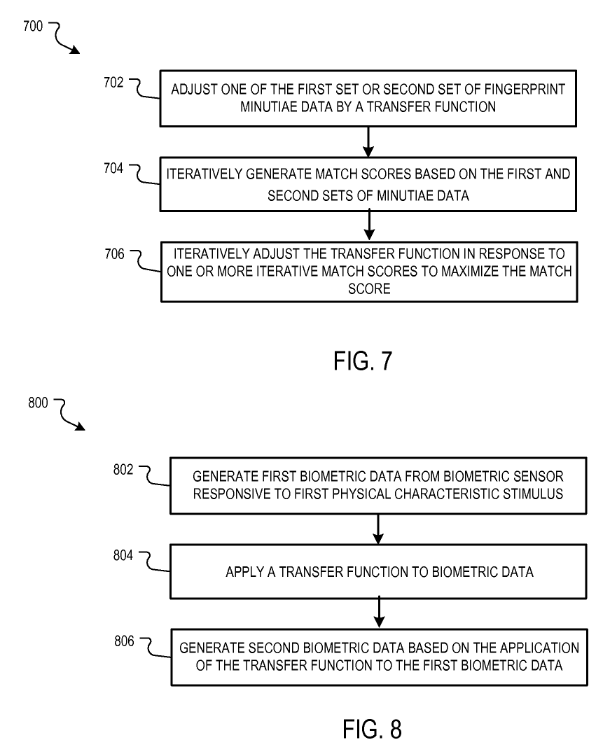

FIG. 7 is a flow diagram of a second example iterative transfer function generation process 800. The process 700 can, for example, be implemented in a system such as the fingerprint processing system 200 of FIG. 2.

Stage 702 adjusts one of the first set or second set of fingerprint minutiae data by a transfer function. For example, the comparison engine 202 can adjust one of the first set or second set of fingerprint minutiae data by a minutiae data filter.

Stage 704 iteratively generates match scores based on the first and second sets of minutiae data. For example, the comparison engine 202 can iteratively generate match scores based on the first and second sets of minutiae data. After each iteration, stage 706 iteratively adjusts the transfer function in response to one or more iterative match scores to maximize the match score. For example, the comparison engine 202 can iteratively adjust the transfer function in response to one or more iterative match scores to maximize the match score.

FIG. 8 is a flow diagram of an example fingerprint generation process 800. The example process 800 can, for example, be implemented in the sensor device 100, processing device 110 and data store 112 of FIG. 1, or in a system such as the fingerprint processing system 200 of FIG. 2, or in any other processing device operable to receive biometric data from a sensor and a biometric data repository.

Stage 802 generates first biometric data from a biometric sensor responsive to a first physical characteristic stimulus. For example, the sensor manufacture 102a can generate electrical signals that are used to generate first biometric data that is output by the sensor device 100a. Likewise, the sensor manufacture 102b can generate electrical signals that are used to generate first biometric data that is output by the sensor device 100b.

Stage 804 applies a transfer function to the first biometric data. For example, a processing device can apply a transfer function to the first biometric data.

Stage 806 generates second biometric data based on the application of the transfer function to the first biometric data. For example, application of the transfer function can cause the processing device of state 804 to generate second biometric data based on the first biometric data. The second biometric data can, for example, be compared to other biometric data of the same type for authentication or identification.

The apparatus, methods, flow diagrams, and structure block diagrams described herein can be implemented in computer processing systems including program code comprising program instructions that are executable by the computer processing system. Other implementations can also be used, such as hardware implementations or a combination of hardware and software implementations. Additionally, the flow diagrams and structure block diagrams described herein, which describe particular methods and/or corresponding acts in support of steps and corresponding functions in support of disclosed structural means, may also be utilized to implement corresponding software and/or hardware structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving a first set of biometric data from a biometric sensor responsive to a first physical characteristic stimulus;
receiving a second set of biometric data from a biometric sensor responsive to a second physical characteristic stimulus, wherein the second set of biometric data is associated with the first set of biometric data;
comparing the first and second set of biometric data; and
generating a transfer function based on the comparison.

2. The method of claim 1, further comprising:
generating a first set of representative data from the first set of biometric data; and
generating a second set of representative data from the second set of biometric data;
wherein comparing the first and second set of biometric data comprises comparing the first and second sets of representative data.

3. The method of claim 1, wherein:
comparing the first and second sets of biometric data comprises:
adjusting one of the first and second sets of biometric data by the transfer function;
iteratively correlating the first set of biometric data with the second set of biometric data; and
generating a transfer function based on the comparison comprises:
iteratively adjusting the transfer function in response to one or more iterative correlations to maximize a correlation coefficient.

4. The method of claim 1, wherein:
the first physical characteristic comprises a flat fingerprint; and
the second physical characteristic comprises a swiped fingerprint.

5. The method of claim 1, wherein:
the first set of biometric data comprises image data; and
the second set of biometric data comprises image data.

6. The method of claim 1, wherein:
the transfer function comprises an image distortion filter.

7. The method of claim 2, wherein:
the first set of representative data comprises first fingerprint minutiae data; and
the second set of representative data comprises second fingerprint minutiae data.

8. The method of claim 7, wherein:
comparing the first and second set of representative data comprises:
adjusting one of the first set or second set of fingerprint minutiae data by the transfer function;
iteratively generating match scores based on the first and second sets of minutiae data; and
generating a transfer function based on the comparison comprises:
iteratively adjusting the transfer function in response to one or more iterative match scores to maximize the match score.

9. The method of claim 8, wherein:
the transfer function comprises a minutia triplet filter.

10. A computer-implemented method, comprising:
generating first biometric data from a biometric sensor responsive to a first physical characteristic stimulus;
applying a transfer function to the first biometric data; and
generating second biometric data based on the application of the transfer function to the first biometric data, wherein the second biometric data corresponds to data from a biometric sensor responsive to a second physical characteristic stimulus.

11. The method of claim 10, wherein:
the first and second biometric data comprises fingerprint minutiae data.

12. The method of claim 11, wherein:
the transfer function comprises a minutiae data filter.

13. The method of claim 10, wherein:
the first physical characteristic stimulus comprises a swiped fingerprint; and
the second physical characteristic stimulus comprises a flat fingerprint.

14. The method of claim 13, wherein:
the first and second biometric data comprises fingerprint image data.

15. The method of claim 14, wherein:
the transfer function comprises an image distortion filter.

16. A system, comprising:
a data store configured to receive and store first and second sets of biometric data corresponding to a first and second biometric stimulus;
a processing device in communication with the data store and configured to:
receive a first set of biometric data from the data store;
receive a second set of biometric data from the data store, wherein the second set of biometric data is associated with the first set of biometric data;
compare the first and second sets of biometric data; and
generate a transfer function based on the comparison.

17. The system of claim 16, wherein:
the processing device is further configured to:
generate a first set of representative data from the first set of biometric data; and
generate a second set of representative data from the second set of biometric data;
wherein comparing the first and second set of biometric data comprises comparing the first and second sets of representative data.

18. The system of claim 16, wherein:
comparing the first and second sets of biometric data comprises:
adjusting one of the first and second sets of biometric data by the transfer function;
iteratively correlating the first set of biometric data with the second set of biometric data; and
generating a transfer function based on the comparison comprises:
iteratively adjusting the transfer function in response to one or more iterative correlations to maximize a correlation coefficient.

19. The system of claim 16, wherein:
the first physical characteristic comprises a flat fingerprint; and
the second physical characteristic comprises a swiped fingerprint.

20. The system of claim 16, wherein:
the first set of biometric data comprises image data; and
the second set of biometric data comprises image data.

21. The system of claim 16, wherein:
the transfer function comprises an image distortion filter.

22. The system of claim 17, wherein:
the first set of representative data comprises first fingerprint minutiae data; and
the second set of representative data comprises second fingerprint minutiae data.

23. The system of claim 22, wherein:
comparing the first and second set of representative data comprises:
adjusting one of the first set or second set of fingerprint minutiae data by the transfer function;
iteratively generating match scores based on the first and second sets of minutiae data; and
generating a transfer function based on the comparison comprises:
iteratively adjusting the transfer function in response to one or more iterative match scores to maximize the match score.

24. The system of claim 23, wherein:
the transfer function comprises a minutia triplet filter.

25. A system, comprising:
a data store in communication with the biometric sensor and configured to receive first and second biometric data;
a processing device in communication with the data store and configured to:
generate first biometric data from a biometric sensor responsive to a first physical characteristic stimulus;
apply a transfer function to the first biometric data; and
generate second biometric data based on the application of the transfer function to the first biometric data, wherein the second biometric data corresponds to data from a biometric sensor responsive to a second physical characteristic stimulus.

26. The system of claim 25, wherein:
the first and second biometric data comprises fingerprint minutiae data.

27. The system of claim 26, wherein:
the transfer function comprises a minutiae data filter.

28. The system of claim 25, wherein:
the first physical characteristic stimulus comprises a swiped fingerprint; and
the second physical characteristic stimulus comprises a flat fingerprint.

29. The system of claim 28, wherein:
the first and second biometric data comprises fingerprint image data.

30. The system of claim 29, wherein:
the transfer function comprises an image distortion filter.
